(19) United States
(12) Patent Application Publication
(10) Pub. No.: US 2006/0015330 A1
(43) Pub. Date: Jan. 19, 2006

(54) Voice coding/decoding method and apparatus

(75) Inventor: Chan Woo Kim, Gyeonggi-do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electonics Inc.

(21) Appl. No.: 11/184,382

(22) Filed: Jul. 18, 2005

(30) Foreign Application Priority Data
Jul. 16, 2004 (KR) 10-2004-0055634

(51) Int. Cl. G10L 19/08

(52) U.S. Cl. 704/219

(57) ABSTRACT

The present invention provides a method of voice coding/decoding. Various parameters computed during voice coding are compressed for transmission. CELP coding of high compressibility and decoding corresponding to CELP coding is implemented without degradation of voice quality and transmission delay. An exemplary method of the present invention comprises performing voice coding, computing a value of at least one characteristic parameter via the voice coding, compressing the computed value of the at least one characteristic parameter, and transmitting the compressed data.

### CROSS REFERENCE TO RELATED APPLICATIONS

Pursuant to 35 U.S.C. § 119(a), this application claims the benefit of earlier filing date and right of priority to Korean Patent Application No. P10-2004-0055634 filed on Jul. 16, 2004, the content of which is hereby incorporated by reference herein in its entirety.

### FIELD OF INVENTION

The present invention relates to voice coding and decoding, and more particularly, to a method of voice coding/decoding and apparatus thereof, by which the voice coding/decoding is applied to a portable terminal and various voice storage/transfer appliances.

### BACKGROUND OF THE INVENTION

The voice coding technology can be mainly categorized into vocoding and waveform coding. And, the voice coding technology can be further categorized into transform coding and coding that applies compression to pulse code modulation (hereinafter abbreviated PCM).

Vocoding utilizes the attribute of voice via Discrete-Time Model. There are technologies corresponding to vocoding such as RELP (random excitation linear prediction) coding, CELP (code excited linear prediction) coding, MELP (mixed excited linear prediction) coding, LPC (linear predictive coding), VSELP (vector sum excited linear prediction) coding, Formant Vocoder, and Cepstral Vocoder.

Meanwhile, a main purpose of waveform coding is to minimize lossless coding or SNR (signal to noise ratio). And, an object of waveform coding is to maintain similarity of waveform.

There are technologies corresponding to waveform coding such as PCM (pulse code modulation), DCM (delta pulse code modulation), DM (delta modulation), ADM (adaptive delta modulation), APC (adaptive predictive coding), ADPCM (adaptive delta predictive code modulation), and Waveform Interpolation Coding.

The coding technology that applies compression to PCM is carried out in a manner that compression is performed after completion of PCM. And, there are coding technology that applies compression to PCM such as Huffman Coding and Coding using LZW (Lempel-Ziv-Welch) algorithm.

CELP coding as one of the vocoding technologies is a representative AbS (analysis-by-synthesis) method.

In CELP coding of AbS, data (codeword) contained in a codebook is synthesized via long-term prediction and short-term prediction so that a difference (error) between the corresponding synthesized result, i.e., synthesized sound, and an original sound is minimized.

A transmitter using CELP coding according to a related art transmits parameters, which are calculated when the difference (error) between the corresponding synthesized result (synthesized sound) and the original sound becomes a smallest value, to a counter side instead of transmitting an original voice. Namely, the parameters computed in the process of vocal tract modeling such as codebook index, codebook gain, pitch period, feedback gain, linear prediction (hereinafter abbreviated LP) coefficient, and the like are transmitted to a receiving side.

The transmitter using CELP coding performs quantization and/or sampling on the various parameters to transmit a corresponding bit stream of predetermined bits.

However, in spite of having more room for compressing the various parameters computed in CELP coding, the related art performs the quantization and/or sampling on the parameters to transmit at a predetermined bit rate.

### SUMMARY OF THE INVENTION

Accordingly, the present invention is directed to a method of voice coding/decoding and apparatus thereof that substantially obviate one or more problems due to limitations and disadvantages of the related art.

The present invention provides a method for voice coding/decoding and apparatus thereof, by which various parameters computed in the voice coding can be appropriately compressed for transmission.

Another object of the present invention is to provide a method of voice coding/decoding and apparatus thereof, by which CELP coding of high compressibility and decoding corresponding to CELP coding can be implemented without degradation of voice quality and transmission delay.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a voice coding/decoding method comprises performing voice coding, computing a value of at least one characteristic parameter via the voice coding, compressing the computed value of the at least one characteristic parameter, transmitting the compressed data, decompressing the compressed data, and performing decoding using a parameter value restore by decompression.

In another aspect of the present invention, a voice coding apparatus comprises a voice coder performing voice coding, at least one compression block compressing at least one characteristic parameter value computed from the voice coder b a predetermined period, and a bit stream transport block rendering an output of the at least one compression block into a bit stream having a predetermined length to transmit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an apparatus for voice coding, according to one embodiment of the present invention;

FIG. 2 is a diagram of a transport form of voice-coded bit stream in accordance with one embodiment;

FIG. 3 is a block diagram of an apparatus for voice coding according to another embodiment of the present invention; and

FIG. 4 is a block diagram of an apparatus for voice decoding according to one embodiment of the present invention.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

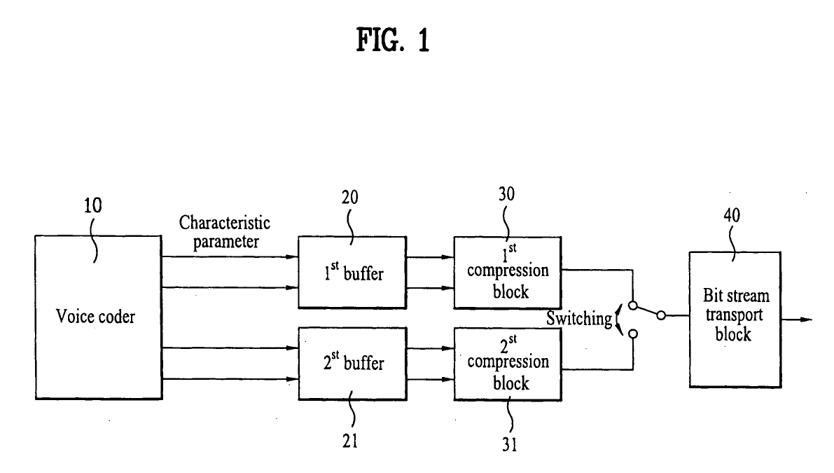

Referring to FIG. 1, an apparatus for voice coding according to the present invention includes a voice coder 10, a first buffer 20, a second buffer 21, a first compression block 30, a second compression block 31, and a bit stream transmitting block 40.

The voice coder 10 computes values of characteristic parameters for voice. In doing so, the values of the parameters are computed in the process of vocal tract modeling as a sort of voice modeling. Specifically, the voice coder 10 outputs the parameter values when a difference (error) between a synthesized result (synthesized sound) via vocal tract modeling and an original sound has a smallest value. Namely, the voice coder 10 outputs the parameter values when a perceptual error between the original and synthesized sounds has a minimum value.

In one embodiment, the parameters computed in the voice coder 10 are distinguished as first type parameters (e.g., type1) and second type parameters (e.g., type2) for convenience of explanation.

The distinction between the parameters is made according to an update period and/or transmission period of the parameters. For instance, the first type parameters are respectively updated by a period within 10 ms, and the second type parameters are respectively updated by a period within 30 ms, for example. The first type parameters are respectively updated by 7.5 ms period, and the second type parameters are respectively updated by 30 ms period in another exemplary embodiment.

In yet another embodiment, the first type parameters are respectively transmitted by a period within 10 ms, and the second type parameters are respectively transmitted by a period within 30 ms. In one example, the first type parameters are respectively transmitted by 7.5 ms period, and the second type parameters are respectively transmitted by 30 ms period.

The update period of a specific parameter is matched to the transmission period of the specific parameter. Namely, if a specific parameter has the update period of 7.5 ms, its transmission period is set to 7.5 ms as well. And, if a specific parameter has the update period of 10 ms, its transmission period is set to 10 ms.

The apparatus for voice coding according to one embodiment comprises the first and second buffers 20 and 21 to classify stored values of the different type parameters, separately.

In one embodiment, the first type parameters are codebook index, codebook gain, pitch period, and feedback gain, which are computed in the voice coder 10. And, the second type parameter is LP (linear prediction) coefficient computed in the voice coder 10.

Hence, the codebook index, codebook gain, pitch period, and feedback gain are stored in the first buffer 20, whereas the LP coefficient is stored in the second buffer 21.

The update period and/or transmission period of the first type parameters are shorter than the update period and/or transmission period of the second type parameters in one embodiment. Hence, a sum of the update period and/or transmission period of a plurality of the first type parameters of which values are stored in the first buffer 20 is set up to be equal to those or that of the second type parameter of which value is stored in the second buffer 21.

For instance, when there are four kinds of the first type parameters and there is one kind of the second type parameter, if the update period and/or transmission period are/is set to 7.5 ms each, the update period or transmission period of the LP coefficient as the first type parameter are set to 30 ms each, for example. On the other hand, if the update period or transmission period of the LP coefficient as the second type parameter are set to, for example 30 ms, the update period or transmission period are set to (30 ms/4=7.5 ms) each, where ‘4’ is the number of parameters.

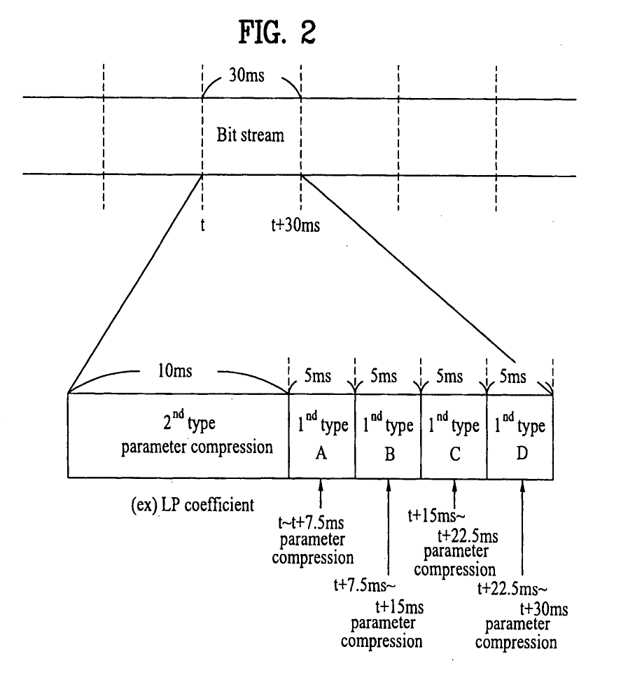

A bit stream transmitted from a portable terminal having the voice coder 10 or a transmitter having the voice coder 10 such as various voice storage/transfer devices is illustrated in FIG. 2. A transmission switching operation in FIG. 1 is performed at a period of 30 ms, for example. The bit stream is then transmitted at 60 ms period.

The above-described update and transmission periods correspond to an operational period of compression performed in the first or second compression block 30 or 31.

The first compression block 30 compresses the values of the parameters stored in the first buffer 20, and the second compression block 31 compresses the values of the parameters stored in the second buffer 21. In doing so, lossless compression is preferably adopted as a compression scheme used in the compression block 30 or 31.

In one embodiment, a bit stream transport block 40 generating a bit stream having a predetermined length, as shown in FIG. 2, is further provided to a rear end of a switch of the apparatus according to the present invention shown in FIG. 1 to secure a predetermined transport rate for data.

The predetermined transport rate of the bit stream transport block is secured in a manner that each length of data outputted from the compression blocks 30 and 31 is made stochastically identical to each other. Namely, if the bit length of the compressed data exceeds a predetermined threshold, the bit stream transport block 40 removes the excessive bits to transport the compressed data having the bit length corresponding to a level of the threshold. On the other hand, if the bit length of the compressed data fails to exceed a predetermined threshold, the bit stream transport block 40 pads meaningless bit value ‘0’ amounting to a necessary length into the compressed data to transport the compressed data having the bit length corresponding to the level of the threshold.

The characteristic parameters, which indicate the error information when the difference between the original and synthesized sounds is minimum, are extracted, lossless compression is performed on the values of the extracted parameters, and the compressed values of a predetermined length are transmitted to the receiving side.

The portable terminal having the apparatus for voice coding or the transmitter having the apparatus for voice coding such as various voice storage/transfer devices performs quantization or sampling on the values of the compressed parameters, generates one bit stream, and then transmits the generated one bit stream to the receiving side.

Subsequently, a portable terminal having an apparatus for voice decoding or a receiver having the apparatus for voice decoding such as various voice storage/transfer devices decompresses the bit stream received at a predetermined rate and then restores the original sound using the values of the parameters according to the decompression in decoding.

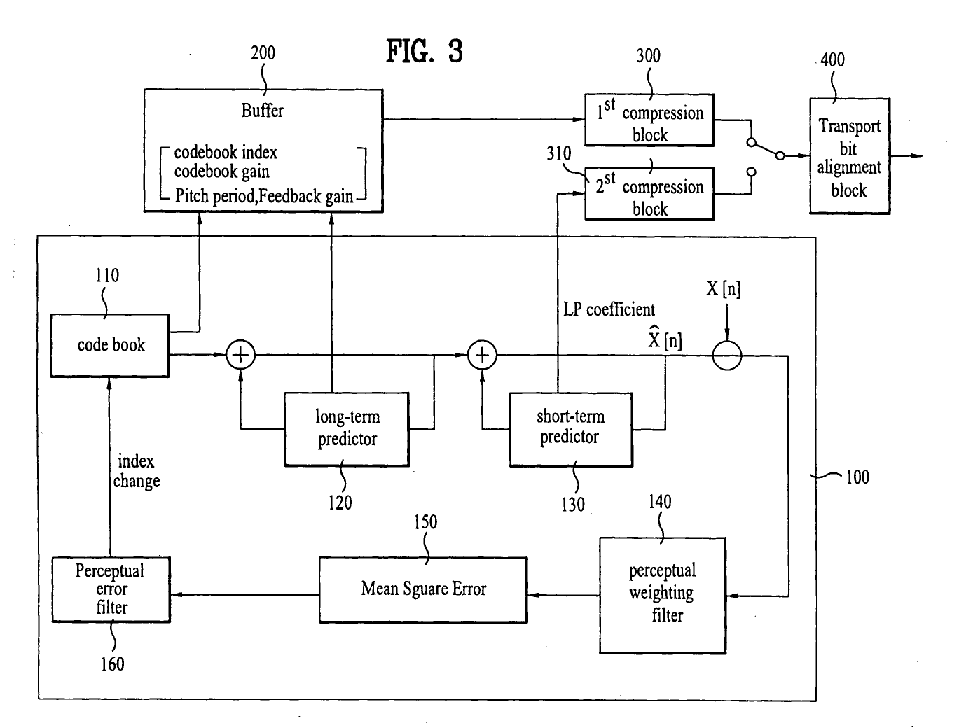

Referring to FIG. 3, an apparatus for voice coding according to one embodiment of the present invention includes a CELP coder 100, a buffer 200, a first compression block 300, a second compression block 310, and a transport bit alignment block 400.

The CELP coder 100 computes values of characteristic parameters most similar to an inputted voice. The CELP coder 100 computes the values of the characteristic parameters via vocal tract modeling.

The CELP coder 100 comprises a codebook 110, a long-term predictor 120, a short-term predictor 130, a perceptual weighting filter 140, a mean square error (hereinafter abbreviated MSE) computing block 150, and a perceptual error filter 160.

The CELP coder 100 computes to output at least one of codebook index, codebook gain, pitch period, feedback gain, and LP coefficient as the characteristic parameters for the inputted voice.

Preferably, the CELP coder 100 computes/outputs values of the parameters corresponding to the case that a difference between a synthesized result (synthesized sound) from via tract modeling of CELP coding and an original sound inputted for CELP coding is the smallest. Namely, the CELP coder 100 outputs the values of the parameters when a perceptual error between the original and synthesized sounds is minimum. In FIG. 3, for example, ‘x[n]’ and ‘{ˆ} atop {x[n]}’ are the original sound and the synthesized sound, respectively.

The CELP coder 100 preferably uses a Gaussian codebook as the codebook 110. The codebook 110 includes codewords having indexes different from each other.

The long-term predictor 120 of the CELP coder 100 is a digital filter performing long-term prediction, whereas the short-term predictor 130 provided to an output end of the long-term predictor 120 is another digital filter performing short-term prediction.

The long-term predictor 120 uses the pitch period and the short-term predictor 130 uses the LP coefficient.

Accordingly, the long-term predictor 120 of the CELP coder 100 outputs the pitch period corresponding to the case that the difference between the synthesized result (synthesized sound) from via tract modeling of CELP coding and the original sound inputted for CELP coding is the smallest. The short-term predictor 130 of the CELP coder 100 outputs the LP coefficient corresponding to the case that the difference between the synthesized result (synthesized sound) from via tract modeling of CELP coding and the original sound inputted for CELP coding is the smallest.

The codewords corresponding to the respective indexes of the codebook 100 are synthesized via a pair of the predictors 120 and 130. The CELP coder 100 utilizes the perceptual weighting filter 140 to minimize the perceptual error between the synthesized sound and the inputted original sound.

In one embodiment, the CELP coder 100 has a feedback path to find the synthesized sound minimizing the perceptual error from the inputted original sound. Therefore, the CELP coder 100 changes the index of the codebook 110 using the feedback path to repeatedly search the codebook 110. The CELP coder 100 determines the synthesized sound closest to the original sound by canceling the perceptual error between the synthesized and original sounds via the codebook search.

When the perceptual error between the synthesized and original sounds is minimized in the CELP coder 100, the present invention computes the index of the codebook 110 used in generating the corresponding synthesized sound as one parameter (codebook index) and the corresponding codebook gain as another parameter.

When the perceptual error between the synthesized and original sounds is minimized in the CELP coder 100, the present invention computes, the pitch period used for the long-term predictor 120 and the LP coefficient used for the short-term predictor 130 as parameters.

Moreover, when the perceptual error between the synthesized and original sounds is minimized in the CELP coder 100, the present invention computes a gain in the feedback path as another parameter (feedback gain).

In brief, when the perceptual error between the synthesized and original sounds is minimized, the CELP coder 100 computes to output codebook index, codebook gain, pitch period, feedback gain, and LP coefficient as the characteristic parameters for the inputted voice.

As the voice is continuously inputted, the above-explained characteristic parameters are updated by a predetermined period. The first and second compression blocks 300 and 310 operate to keep up with the update period of the parameters, accordingly. It is a matter of course that the transmission period of the compressed data is decided to cope with the operation period (compression period) of the compression blocks 300 and 310.

In one embodiment, the update period for the codebook index, codebook gain, pitch period, or feedback gain is preferably set up to be smaller than that for the LP coefficient. For example, the update period for the codebook index is set to about 10 ms and the update period for the LP coefficient is set to about 30 ms. The rest period for the codebook gain, pitch period, or feedback gain is set to about 10 ms, for example.

One embodiment further comprises the buffer 200 to previously store the parameters (codebook index, codebook gain, pitch period, feedback gain) having the faster update periods therein. A compression timing between the parameters having the faster update periods and the parameters (LP coefficient, etc.) having slower update periods is matched. A sum of the update periods of the codebook index, codebook gain, pitch period, and feedback gain is set up to be equal to a value of the update period of the LP coefficient. Namely, if an update period for one parameter is set to, for example 7.5 ms, it takes 30 ms to store the codebook index, codebook gain, pitch period, and feedback gain in the buffer 200. The update period of the LP coefficient is set to about 30 ms in one embodiment.

In order to compress parameters distinguished from each other according to the corresponding update period in separate blocks, the first and second compression blocks 300 and 310 are provided in accordance with one embodiment. The first compression block 300 compresses the parameters (codebook index, codebook gain, pitch period, feedback gain) temporarily stored in the buffer 200. The second compression block 310 compresses the LP coefficient computed/outputted by the short-term predictor 130 of the CELP coder 100. In doing so, the compression blocks 300 and 310 adopt lossless compression each.

The update periods for the parameters and the corresponding construction of a system according to an exemplary embodiment is provided below.

In a preferred embodiment, the update periods of the respective parameters (codebook index, codebook gain, pitch period, feedback gain, LP coefficient) are set up to be different from each other, and a timing for compressing the respective parameters is matched using a plurality of the buffers. The blocks for compressing the parameters respectively are provided.

The update periods of the respective parameters (e.g., codebook index, codebook gain, pitch period, feedback gain, LP coefficient) outputted from the CELP coder 100 are setup to be identical to each other. One or more buffers maybe used. One block for compression of the parameters temporarily stored in the buffer is provided.

In another embodiment, a switch (not shown in the drawing) for controlling output paths of the compression blocks 300 and 310 is provided between rear ends of the first and second compression blocks 300 and 310.

As each of the codebook index, codebook gain, pitch period, and feedback gain stored in the buffer 200 has the update period of, for example 7.5 ms, the first compression block 300 performs the compression operation by about 30 ms period. For example, as the LP coefficient has the update period of 30 ms, the second compression block 310 performs the compression operation in about 30 ms. Hence, the switch performs a switching operation on the first and second compression blocks 300 and 310 in approximately 30 ms in an exemplary embodiment.

The transport bit alignment block 400 merges outputs of the first and second compression blocks 300 and 310 into one bit stream to output. The transport bit alignment block 400, which is a block for securing a constant transport rate of the compressed data, renders a length of the data outputted from the compression blocks 300 and 310 uniform to transmit the rendered data.

In order to transmit the compressed data in uniform length, the transport bit alignment block 400 sets up a stochastic threshold for the bit length. For example, if the 100% transport length is 100-bits, the transport length of the bit stream that will be transmitted from the transport bit alignment block 400 is set to 99% thereof. If one compressed data length is 101-bits, for example, the transport bit alignment block 400 transmits the compressed data amounting to 99-bits length to the receiving side.

If one compressed data length is 96-bits, for example, the transport bit alignment block 400 inserts a dummy of meaningless 3-bits in the compressed data length to provide a 99-bits length to transmit to the receiving side. In doing so, the dummy insertion is carried out in a manner that, for example, ‘0’s are padded into a part of the compressed data.

In another example, the present invention may further include a buffer (not shown in the drawing) at an input end of the second compression block 310 to temporarily store the LP coefficient. In the following description, the buffer for storing the LP coefficient temporarily is named a second buffer and the foregoing buffer 200 is denoted by a first buffer 200.

In one embodiment, as mentioned in the foregoing description, the update period for the codebook index, codebook gain, pitch period, or feedback gain is set up to be smaller than that for the LP coefficient. Hence, the period of storing the codebook index, codebook gain, pitch period, or feedback gain in the first buffer is set up to be smaller than that of storing the LP coefficient in the second buffer.

For example, the period of storing the codebook index, codebook gain, pitch period, or feedback gain in the first buffer is set to about 10 ms and the period of storing the LP coefficient in the second buffer is set to about 30 ms.

In another embodiment, the storing period of each of the parameters in the first buffer is set to about 7.5 ms and the storing period of the parameter (LP coefficient) in the second buffer is set to about 30 ms.

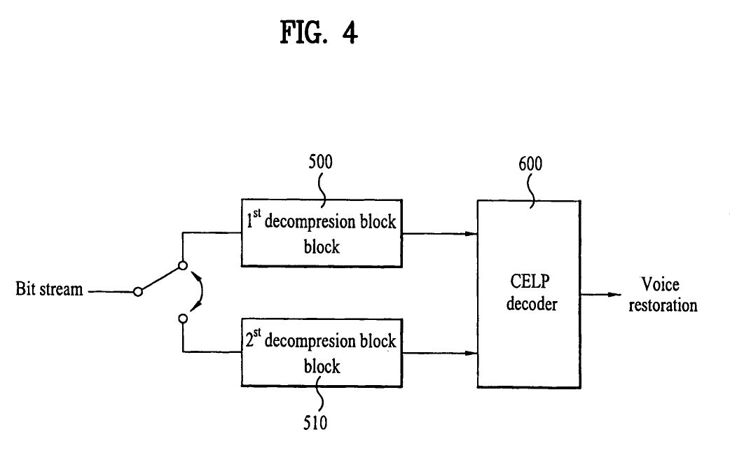

A portable terminal having an apparatus for voice decoding or a receiver having the apparatus for voice decoding such as various voice storage/transfer devices decompresses the bit stream received at a predetermined rate and then restores the original sound using the values of the parameters according to the decompression in decoding, which is explained by referring to FIG. 4.

FIG. 4 is a block diagram of an apparatus for voice decoding according to one embodiment of the present invention, which prepares for the case of using the apparatus for voice coding in FIG. 3.

Referring to FIG. 4, an apparatus for voice decoding according to the present invention includes first and second decompression blocks 500 and 510 decompressing a received bit stream and a CELP decoder 600. And, the apparatus for voice decoding according to the present invention includes a switch (not shown in the drawing) for transferring the received bit stream to the corresponding decompression block 500 or 510.

The switch (not shown in the drawing) performs a switching operation to transfer bits corresponding to codebook index, codebook gain, pitch period, or feedback gain to the first decompression block 500 or to transfer bits corresponding to LP coefficient to the second decompression block 510.

The first or second decompression blocks 500 or 510 decompresses inputted data to output to the CLP decoder 600. An operation of the CLP decoder 600 can be understood from the coding operation of the CELP coder described in FIG. 3.

Another embodiment comprises a control block (not shown in the drawing) controlling the switching operation of the switch. The control block classifies the received bit streams into a first type and a second type if the transmitted bit streams are defined by the format of FIG. 2, for example. And, the control block controls the switching operation in a manner that the bits corresponding to the first type parameters (codebook index, codebook gain, pitch period, feedback gain) are transferred to the first decompression block 500 and the second type parameter (LP coefficient) is transferred to the second decompression block 510.

The present invention allows various kinds of voice coding such as MELP (mixed excited linear prediction) coding and RELP (residual excited linear prediction) coding as well as CELP coding.

Accordingly, the present invention provides to secure high compressibility of voice coding and its corresponding voice decoding without voice quality degradation and transmission delay.

The various parameters computed by CELP coding are compressed by lossless compression to be transmitted, whereby the present invention provides higher compressibility of CELP coding.

The present invention can be advantageously applied to portable terminals and transmitters of various voice storage/transfer devices such as a language player, a digital recorder, a VoIP (voice over Internet protocol) terminal etc.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A voice coding/decoding method comprising:
performing voice coding;
computing a value of at least one characteristic parameter via the voice coding;
compressing the computed value of the at least one characteristic parameter; and
transmitting the compressed data;
wherein the compressed data is decompressed to restore a parameter value used to decode coded voice.

2. The method of claim 1, wherein the voice coding comprises vocoding.

3. The method of claim 1, wherein the voice coding is code excited linear prediction (CELP) coding.

4. The method of claim 1, wherein the computed value of the at least one characteristic parameter is a value representing that an error between a synthesized sound by the voice coding and a voice inputted to the voice coding is less than a first threshold.

5. The method of claim 4, wherein the at least one characteristic parameter comprises at least one of a codebook index, a codebook gain, a pitch period, a feedback gain, and a linear prediction coefficient.

6. The method of claim 5, wherein the pitch period is used in long-term prediction.

7. The method of claim 5, wherein the linear prediction coefficient is used in short-term prediction.

8. The method of claim 5, further comprising temporarily storing the codebook index, the codebook gain, the pitch period, the feedback gain, and the linear prediction coefficient prior to the compressing step.

9. The method of claim 5, wherein an update period of each of the codebook index, the codebook gain, the pitch period, and the feedback gain is set to be shorter than that of the linear prediction coefficient.

10. The method of claim 9, wherein a sum of the update periods of the codebook index, the codebook gain, the pitch period, and the feedback gain is set to be equal to the update period of the linear prediction coefficient.

11. The method of claim 1, wherein the compressing step is performed by lossless compression.

12. The method of claim 1, wherein the compressed data is transmitted by a predetermined bit unit.

13. A voice coding apparatus comprising:
a voice coder performing voice coding;
at least one compression unit compressing at least one characteristic parameter value computed by the voice coder in a predetermined period; and
a bit stream transport unit rendering an output of the compression unit into a bit stream having a predetermined length.

14. The apparatus of claim 13, wherein the voice coder is a code excited linear prediction (CELP) coder.

15. The apparatus of claim 13, wherein the compression unit compresses the characteristic parameter value, computed wherein the characteristic parameter value is when an error between a sound synthesized by the voice coder and a voice inputted to the voice coder is less than a first threshold.

16. The apparatus of claim 13, wherein the compression block performs lossless compression.

17. The apparatus of claim 13, wherein the characteristic parameter comprises at least one of a codebook index, a codebook gain, a pitch period, a feedback gain, and a linear prediction coefficient.

18. The apparatus of claim 17, further comprising at least one buffer temporarily storing at least one of the codebook index, the codebook gain, the pitch period, the feedback gain, and the linear prediction coefficient prior to compressing.

19. The apparatus of claim 18, further comprising:
a first buffer temporarily storing at least one of the codebook index, the codebook gain, the pitch period, and the feedback gain; and
a second buffer temporarily storing the linear prediction coefficient.

20. The apparatus of claim 19, wherein an update period of at least one of the codebook index, the codebook gain, the pitch period, and the feedback gain in the first buffer is set to be shorter than that of the linear prediction coefficient in the second buffer.

21. The apparatus of claim 20, wherein a sum of the update periods of the codebook index, the codebook gain, the pitch period, and the feedback gain is set to be equal to the update period of the linear prediction coefficient.

22. The apparatus of claim 19, further comprising:
a first compression unit compressing a parameter value stored in the first buffer; and
a second compression unit compressing a parameter value stored in the second buffer.
